(19) United States
(12) Patent Application Publication
(10) Pub. No.: US 2003/0153201 A1
(43) Pub. Date: Aug. 14, 2003

(54) Circuit board electrical lead frame

(76) Inventor: Edward W. Burger, Fernandina Beach, FL (US)

Correspondence Address: Edward E. Roberts, P.O. Box 3206, Dana Point, CA, 92629, US

(21) Appl. No.: 10/074,429

(22) Filed: Feb. 13, 2002

(51) Int. Cl. H01R 12/00

(52) U.S. Cl. 439/79

(57) ABSTRACT

An electrical lead frame comprised of a plurality of spaced generally rigid commercially available conductors, each generally continuous and uniform with a rectangular or circular cross-section. The conductors are arranged in a planar array and each bent to provide a mounting portion for mounting to the connector shell and a generally reversed J-shaped portion having the long side connected to and depending from the mounting portion. The bottom of the reversed J-shaped portion forms a connector portion for connection to the circuit board with the reversed J-shaped portion then terminated in a free end portion extending upwardly from the connector portion. The array of conductors is held in spatial registration by chemical film strip means inter-fastened to the conductor's adjacent free end portions of the conductors and affixed in a direction generally perpendicular to the direction of the conductors. The film strip has a width in the direction of alignment of the conductors that is very small in proportion to the total length of the conductors and a thickness that approximates the thickness of the conductors except at the point of intersection of the strip with the conductor At this intersection the film about the conductor provides increased thickness providing greater stability for minimal skewing or misalignment of the conductors during handling.

### BACKGROUND OF THE INVENTION

The background of the invention will be discussed in two parts.

1. Field of the Invention

This invention relates to electrical circuit board mounted electrical lead frames, and more particularly to a lead frame having a planar array of non-flexible continuous unitary miniature conductors of uniform cross-section held in spaced aligned registration enabling improved automated and manual handling during the manufacture, testing, packaging, shipping, unpacking and assembly processes.

2. Description of the Prior Art

With present day printed circuit board technology, surface mounted and through-hole devices proliferate. Such devices simplify the manufacturing process while eliminating parts and components previously required. Such circuit board mounted devices include IC packages, resistor (and other passive device) networks, as well as connectors. For circuit board mounted devices, automated handling is employed, such as “pick and place” machines which automatically select the component and place it at the desired location for attachment, such as by soldering.

With connector assemblies, a plurality of leads are usually arranged in an array, and usually consisting of one or more sets. Typically, each set is of a planar arrangement with the leads of a set in alignment with one another, usually on an equally spaced basis, with spacing between leads usually being less than one millimeter in dimension. With small cross-section conductors closely spaced, mechanical handling during manufacture and assembly of the conductors with automated machines can often result in bent or deformed conductor ends or misaligned adjacent conductors.

A prior art device is shown and described in U.S. Pat. No. 4,964,806, issued to Sakamoto et al on Oct. 23, 1990, wherein a Surface Mounting Connector is disclosed that utilizes a pin holder mounted to the circuit board for receiving the ends of the connector conductors for attachment.

U.S. Pat. No. 5,471,097, issued to Shibata in November 1995, discloses supporting strips for maintaining conductors in spaced aligned registration.

In light of the above, and other prior art, what is needed is a circuit board electrical lead frame providing for a planar array of non-flexible continuous miniature conductors of uniform cross-section with the conductors held in spaced aligned registration allowing for essentially rigid areas void of insulating film. Formed in such manner, the lead frame would provide various advantageous aspects including, but not limited to, improved hand and automated handling during manufacturing and assembly.

It is thus an aspect of the present invention to provide an improved electrical lead frame for holding miniature conductors in spatial registration both during insertion into electrical contact termination machines and during insertion of terminated lead frames into connector insulators.

It is another aspect of the invention to provide an improved ruggedized electrical lead frame for holding miniature conductors in spatial registration to allow for manual and machine handling during connector manufacture, testing, packaging, shipping, unpacking and assembly processes.

It is yet another aspect of the present invention to provide an improved circuit board electrical lead frame that employs a plurality of generally rigid continuous unitary conductors having filmstrip means for supporting the conductors in a planar array in spaced aligned registration.

It is a further aspect of the invention to provide a non-flexible electrical lead frame having essentially rigid areas void of insulating film thus allowing for forming the continuous conductors of uniform cross-section in film-less areas.

It is still further an aspect of the invention to employ individual round or rectangular commercially available conductors instead of a metallic sheet, the conductors thus not requiring chemical or mechanical milling techniques in preparation for use.

It is yet another aspect of the invention to employ conductors that are without flexible areas, rather, to provide for semi-rigid film-less conductor areas.

It is still another aspect of the invention to employ conductors that are continuous with uniform dimensions throughout their length without reduced thickness areas thus providing greater current capacity with lower conductor resistance per length and there being no requirement for plating to increase selective thickness.

### SUMMARY OF THE INVENTION

In accordance with the present invention, there is provided an electrical lead frame for insertion into a connector shell comprised of a plurality of spaced generally rigid conductors, each generally continuous and uniform with a rectangular or circular cross-section. Whether rectangular or circular in configuration, the invention typically uses commercially available conductors instead of a metallic sheet. Thus, the invention has no flexible area, rather, it provides for semi-rigid areas void of insulating film thus allowing for forming the conductors in film-less areas. The conductors are arranged in a planar array and each bent to provide a mounting portion for mounting to the connector shell and a generally reversed J-shaped portion having the long side connected to and depending from the mounting portion. The bottom of the reversed J-shaped portion forms a connector portion for connection to the circuit board with the reversed J-shaped portion then terminated in a free end portion extending upwardly from the connector portion.

The array of conductors is held in spatial registration by chemical filmstrip means common to the conductors and affixed adjacent the free end portions of the conductors. The common filmstrip is affixed in a direction generally perpendicular to the direction of the conductors and has a width in the direction of alignment of the conductors that is very small in proportion to the total length of the conductors The common filmstrip and has a thickness that approximates the thickness of the conductors except at the point of intersection of the strip with the conductor at which intersection the film about the conductor provides increased thickness providing greater stability for minimal skewing or misalignment of the conductors during handling. The greater stability also provides alignment maintenance during mass crimp termination of contacts to the conductors.

Thus, the invention has at least the following differences from and advantages over the prior art devices as follows:

(1) the invention uses individual round or rectangular commercially available unitary conductors instead of a metallic sheet, and thus require no plating increase thickness since they are continuous and have uniform cross-sections throughout their length;

(2) the conductors of the invention have no reduced thickness areas thus providing greater relative current capacity along with lower conductor resistance per length;

(3) the invention has no flexible area, rather, it provides for semi-rigid areas void of insulating films thus allowing for forming the conductors in film-less areas;

(4) the invention does not use chemical or mechanical milling techniques to prepare the conductors,

(5) the invention requires only one laminating film for maintaining co-planar registration of the conductors both to each other and to the connector mounting surface to which the conductors become an integral part;

(6) the invention does not require shaping of the conductor ends; and no tabs are required in the invention.

The foregoing and other aspects, objects, features and advantages of the invention will become more apparent from a reading of the specification when taken in conjunction with the drawings, in which like reference numerals refer to like elements in the several views.

### BRIEF DESCRIPTION OF THE DRAWINGS

FIG. 1 is a cross-sectional view of the connector and lead frame apparatus in accordance with the invention;

FIG. 2 is a top plan view of the connector and lead frame apparatus of FIG. 1; and

FIG. 3 is a front view of a typical connector of the apparatus of FIG. 1 showing the insertion aperture pattern

### DESCRIPTION OF THE PREFERRED EMBODIMENT

Referring now to the drawings in general, there is shown a ruggedized circuit board electrical lead frame providing for a planar array of non-flexible continuous unitary miniature conductors of uniform cross-section held in spaced aligned registration allowing for essentially rigid areas void of insulating film. The means for holding the conductors in spatial registration allows for manual and machine handling during connector manufacture, testing, packaging, shipping, unpacking and assembly processes. The conductors are held in spaced aligned registration by filmstrip means as further described below.

Turning now to the figures, connector shell 8 is shown with contacts 16, 26 for accepting first and second conductor arrays, generally designated 10 and 20, of substantially rigid conductors. As shown, the two sets of conductor arrays, 10 and 20, are connected to the two offset rows of apertures 50 of connector shell 8, connector shell 8 having contacts 16, 26 for accepting first and second conductor arrays 10 and 20, respectively. The conductors 10, seven indicated, form a first part of the lead frame. The conductors 20, eight being indicated, form a second similarly configured, but dimensionally smaller, part of the lead frame Although two sets of conductors are shown and described, it is to be understood that one or more sets of conductors may be used for the surface mount apparatus of the invention.

The invention typically uses individual generally rigid round commercially available conductors, such as 30 AWG solid copper plated conductors, instead of a metallic sheet However, they may also be of a different configuration, such as generally rectangular The conductor array therefore has no flexible area, rather, it provides for semi-rigid areas void of insulating film thus allowing for forming the conductors in film-less areas Thus, the use of chemical or mechanical milling techniques to prepare the conductors is not required

Further, no plating of the conductors is required to increase thickness since they are continuous and uniform throughout their length. Having no reduced thickness areas the conductors have greater relative current capacity along with lower conductor resistance per length. As formed, shaping of the conductor ends is not required, nor are any tabs used in the invention. The invention provides an electrical lead frame having essentially rigid areas void of insulating film, thus allowing for forming the continuous conductors of uniform cross-section in film-less areas In general, the conductor thickness dimension is about five mils with about 25 mils spacing between conductors.

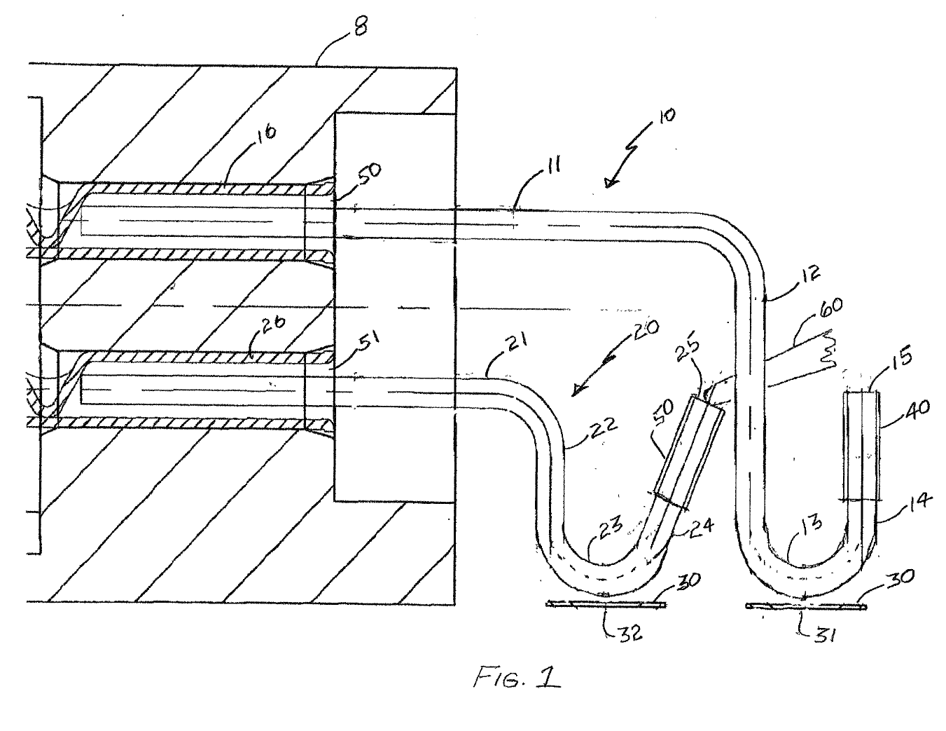

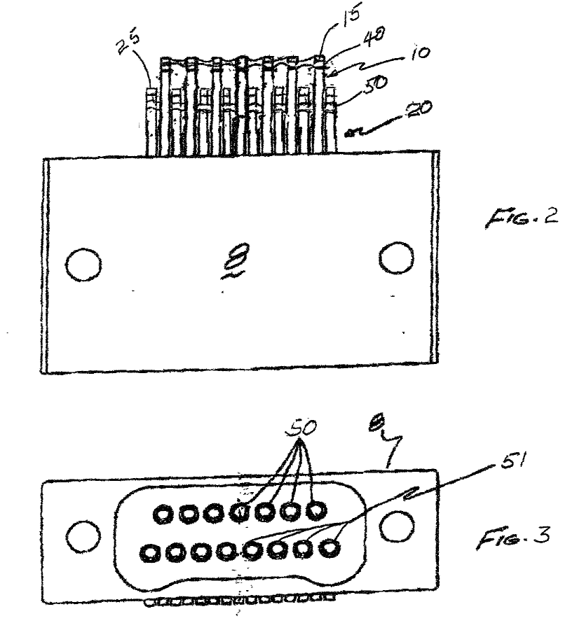

In the drawings there are shown two sets of conductors, 10 and 20, for providing connection to the two offset rows of apertures 50 of connector shell 8. As better illustrated in the elevational view of FIG. 1, the lead frame 10 is formed of an array of conductors, seven being indicated, each configured to provide mounting portion 11 and a generally reversed J-shaped portion. Mounting portions 11 are connected to connector shell 8 and extend therefrom generally parallel to the surface of circuit board 30. The long side 12 of the generally reversed J-shaped portion is connected to and depends downwardly toward the circuit board surface 30 at approximately a right angle from the mounting portion 11. The curved bottom portion 13 of the reversed J-shaped portion includes a connector surface for electrical connection to the circuit board at contact 31. The other, or short, side of the reversed J-shaped portion is curved upwardly from circuit board 30 and terminates in free end portion 14. Side 12 and end portion 14 are substantially parallel; that is, the reversed J-shaped portion is bent in horseshoe fashion through substantially 180 degrees. In this reversed J-shaped configuration side 12 is dimensionally longer than end portion 14. The end portion 14 is of a length adequate to accept stabilizing filmstrip 40 and to provide soldering contact point 15 at the tip of end portion 14 Soldering contact point 15 provides for re-flow soldering of connector portion 13 to the circuit board contact 31

The array of conductors of lead frame 10 is held in spatial registration by a common chemical filmstrip 40 affixed to the free end portions 14 of the conductors Filmstrip 40 is affixed in a transverse direction generally perpendicular to the direction of the conductors 10 It has a width in the direction of alignment of the conductors that is very small in proportion to the total length of the conductors, and has a thickness that approximates the thickness of the conductors, except at the point of intersection of the strip with the conductor At this intersection the film about the conductor provides increased thickness serving to provide greater stability for minimal skewing or misalignment of the array during the manufacturing and circuit assembly operations. For instance, this improved stability provides required alignment maintenance during mass crimp termination of conductor connector portions 13 to circuit board contacts 31

The conductors 20, eight being indicated, form part of a second lead frame that is similarly configured, but dimensionally smaller than lead frame 10. Although two sets of conductors are shown and described, it is to be understood that one or more sets of conductors may be used for the surface mount apparatus of the invention Conductors 20 are also generally circular of substantially identical semi-rigid commercially available material, and are typically 30 AWG solid copper plated conductors. However, they also may be of a different configuration, such as generally rectangular.

Conductors 20 further have portions 21, 22, 23 and 24, corresponding to the respective mounting portion and reversed J-shaped portion of conductors 10. However, portion 22 must necessarily be shortened to account for the closer proximity of conductors to circuit board 30 That is, to properly meet circuit board contact point 32, portion 22 is formed shorter than portion 12 of conductor 10. Thus, whereas portion 12 and end portion 14 of conductors 10 are bent substantially parallel, the reversed J-shaped portions of conductors 20 are bent through substantially 135 degrees, that is, portion 22 and end portion 24, if extended to intersect, would form an intersection angle of about 45 degrees. In this form the reversed J-shaped configuration is foreshortened to appear perhaps more in a skewed U-shaped configuration rather than a reversed J-shaped configuration. End portion 24 is also of a length to accept filmstrip 50 and to provide contact point 25 for re-flow soldering of connector portion 23 to the circuit board contacts 32, as indicated by soldering tool 60.

The individual conductors of each lead frame 10, 20 are maintained in spaced aligned registration by means of chemical filmstrips 40 and 50, respectively. Each filmstrip 40, 50 has a given width in the direction of alignment of their respective conductors that is very small in proportion to the total length of the respective conductors 10, 20 In thickness, the chemical filmstrips approximate the thickness of the conductors except at the point of intersection of the strip with the conductor. At such intersection, the film about each of the conductors provides an increased thickness for minimizing skewing or misalignment of the conductors during handling. In each case the filmstrips are fused or bonded across the plurality of conductors and located to position and maintain the spacing of the conductors in relation to one another This, combined with the increased thickness, ruggedizes the conductors for improved manual and machine handling.

The strips 40, 50 are configured to expose the remaining length of the conductors, that is, contact points 15, 25, for ease of forming to various permanent shapes, such as termination to electrical circuits while maintaining lead spacing and co-planarity. As an advantage, by maintaining the spatial registration of the conductors, matching characteristics with insulator hole spacing, printed board pads and through-hole vias are provided. Although not shown, for circuit board through-hole mounting, the curved connector portions 31,32 are configured and arranged to be continuations of portions 12, 22 to thereby extend generally perpendicularly through the circuit board 30

Additionally, a sufficiently firm abutting surface is provided at connector contacts 16 and 26 for respective connector portions 11 and 21, as well as at circuit board surfaces 31, 31 for mounting portions 31, 32. This provides adequate strength for accepting the thrust of manual or automated machine tools during manual and machine handling.

The combination of materials and configuration operates to prevent peeling of conductor plating due to insertion tool slippage, with resulting exposure of bare conductor metal, which decreases short circuit problems between conductors. Also, skewing of conductors during insertion is eliminated. The materials used in construction of the lead frame of the invention, that is, the conductor material and the chemical film, are chosen to provide the required strength and rigidity for accurate machining and manual handling of during connector manufacture, testing, packaging, shipping, unpacking and assembly processes.

Thus, with the unit assembled as shown and described, the rigid nature of the lead frames 10, 20 provide a more rugged unit that enables maintaining of the conductors in proper registration while avoiding skewing or misalignment of individual conductors. The lead frame as constructed also provides required strength during insertion of terminated lead frames into connector insulators. The apparatus as shown and described provides at least the following characteristics and advantages:

(1) the conductors are inter-fastened and made rigid in the film bonded areas while allowing for desired formation outside of the bonded area;

(2) alignment and co-planarity of lead ends are maintained during subsequent machine or manual soldering or attachments to electrical circuits;

(3) skewing of conductors is prevented during cutoff-to-size operations;

(4) machine placement of electrical connectors and elimination of manual placement errors reduces rework and associated costs, and packaging, shipping and unpacking is simplified since spacing and co-planarity is maintained.

While there has been shown and described a preferred embodiment, various adaptations and modifications may be made without departing from the spirit and scope of the invention.

What is claimed is:

1. An electrical lead frame for mounting to a circuit board comprising
a connector shell formed for receiving a plurality of planar generally rigid electrical conductors;
said plurality of conductors each having a one end portion thereof for insertion, termination and electrical connection within said connector shell; and
alignment means inter-fastened to said conductors adjacent the other end thereof to maintain said conductors in a planar array having spaced aligned registration.

2. The lead frame of claim 1 wherein said one end portion extends from said connector shell and is bent downwardly to form a generally reversed J-shaped configuration with the bottom arc thereof extending outwardly from said connector shell and having means thereon for connection to said circuit board and then extending upwardly to terminate in said other end portion.

3. The electrical lead frame of claim 1 wherein said alignment means includes at least one filmstrip inter-fastened transversely to said conductors and having a width in the direction of alignment of the conductors, which width is very small in proportion to the total length of the conductors, and in thickness said filmstrip approximating the thickness of the conductors with the point of intersection of the strip with the conductor having an increased thickness.

4. The lead frame of claim 3 wherein said alignment means is a single filmstrip transversely encapsulating each of said conductors and wherein said conductors are maintained substantially in parallel.

5. The lead frame of claim 2 wherein said reversed J-shaped configuration includes a first portion bent generally perpendicularly downward from said one end portion followed by an arc-shaped portion configured for mounting to said circuit board followed by said other end portion bent upwardly from said circuit board at an angle of from 45 10 90 degrees.

6. A surface mount connector apparatus comprising:
a connector shell having apertures forming an electrical connection pattern with contact members in at least some of said apertures;
an electrical lead frame having a plurality of generally rigid continuous unform conductors, said conductors formed to provide a mounting portion configured for mounting to a printed circuit board and a connector portion for insertion into said contact members of said connector shell; and
supporting means including at least one chemical film strip inter-fastened to said conductors at a selected location for maintaining said conductors in spaced aligned registration to each other and to said mounting circuit board.

7. The connector apparatus of claim 6 wherein said conductors of said planar array are formed to further include central portions intermediate said mounting and connector portions, and free end portions extending beyond said mounting portions in a direction generally parallel to the direction of said central portions.

8. The connector apparatus of claim 7 wherein said supporting means is a single film strip inter-fastened to said free end portions.

9. The connector apparatus of claim 8 wherein said film strip on said free end portions is spaced a distance from the terminal ends of said free end portions which distance is sufficient to provide a contact point at said terminal ends for re-flow soldering of said connector portions to said circuit board.

10. The connector apparatus of claim 8 wherein said filmstrip has a width in the direction of alignment of the conductors which is very small in proportion to the total length of the conductors and in thickness which is approximate the thickness of the conductors, with the point of intersection of the strip with the conductor having an increased thickness

11. An electrical lead frame comprising.
a plurality of generally rigid conductors each formed with a connector portion for contact mass termination and insertion into a connector shell, a mounting portion configured for mounting to a printed circuit board, a central portion intermediate said mounting portion and said connector portion, and a free end portion extending upwardly beyond the mounting portion,
a chemical film strip for supporting said conductors in a planar array, said film strip means inter-fastened to said conductors for maintaining said conductors in spaced aligned registration; and
wherein said connector portion and said mounting portion are substantially in parallel, and said central portion and said free end portion are substantially perpendicular to said connector portion and said mounting portion.

12. The lead frame of claim 11 wherein said central portion, said connector portion and said free end portion of said conductors are generally of reversed J-shaped configuration with said central portion bent downwardly from said connecting portion at approximately 90 degrees, said mounting portion bent in arc-like manner away from said connector shell at approximately 90 degrees from said central portion, and said free end portion bent generally upwardly from said mounting portion.

13. The lead frame of claim 12 wherein said film strip is displaced from the termination of said free end portion a distance sufficient to provide a contact point at said terminal ends for re-flow soldering of said mounting portions to said circuit board.

14. The lead frame of claim 12 wherein each of said conductors is continuous with a generally uniform cross-section and said connector portion is formed into a 135 to 180 degree arc from which said free end portion extends

15. The lead frame of claim 14 wherein each of said conductors are commercially available without the requirement of chemical or mechanical milling techniques in production of the lead frame.

16. A surface mount connector apparatus comprising.
a connector shell having apertures forming an electrical connection pattern, contact members in at least some of said apertures;
an electrical lead frame having a plurality of generally rigid continuous conductors having generally uniform cross-section;
film strip means for supporting said conductors in a planar array, said conductors formed to provide a connector portion for insertion into said contact members of said connector shell, a mounting portion configured for mounting to a printed circuit board, and a free end portion, said film strip inter-fastened transversely of said conductors adjacent the termination of said free end portion so as to maintain lead spacing and co-planarity of said conductors.

17. The connector apparatus of claim 16 wherein said film strip has a width in the direction of alignment of the conductors, which width is very small in proportion to the total length of the conductors, and in thickness, said strip is approximate the thickness of the conductors with the point of intersection of the strip with the conductor having an increased thickness.

18. The connector apparatus of claim 16 wherein said film strip on said free end portions is spaced a distance from the terminal ends of said free end portions which distance is sufficient to provide a contact point at said terminal ends for re-flow soldering of said connector portions to said circuit board.

19. A surface mount connector apparatus comprising:
an electrical lead frame having a plurality of rigid unitary conductors;
a connector shell having contact members forming an electrical connection pattern for receiving said conductors,
said conductors formed to provide a mounting portion configured for mounting to a printed circuit board, a connector portion for insertion into said contact members of said connector shell, and a free end portion extending beyond said mounting portion; and
at least one chemical film strip inter-fastened to said conductors adjacent the termination of said free end portions in a direction generally perpendicular to the direction of said conductors for maintaining lead spacing and co-planarity of said conductors in a planar array.

20. The connector apparatus of claim 19 wherein each of said conductors of said planar array conductors are continuous and of generally uniform cross-section and are formed to include a central portion intermediate of and generally at a right angle to said mounting and connectors portions and said mounting portion continues into said free end that is directed away from said mounting portion at generally a 45 to 90 degree angle from said mounting portion
